(19) United States
(12) Patent Application Publication
(10) Pub. No.: US 2010/0087211 A1
(43) Pub. Date: Apr. 8, 2010

(54) PROXIMITY MARKETING SERVER APPARATUS

(76) Inventor: Daniel Hurd, Shelby Township, MI (US)

Correspondence Address: YOUNG BASILE, 3001 WEST BIG BEAVER ROAD, SUITE 624, TROY, MI, 48084, US

(21) Appl. No.: 12/244,226

(22) Filed: Oct. 2, 2008

(51) Int. Cl. H04W 4/00

(52) U.S. Cl. 455/466

(57) ABSTRACT

Prepared content assessable by a server is transmitted to a mobile communication device having wireless communication capability. A proximity broadcast node coupled to the server by a network detects if a mobile communication device within a data communication range of the node. The node then attempts to establish a peer-to-peer connection with the mobile device. When a connection is established, the node delivers the prepared content to the mobile device. If the user of the mobile device ignores the connection or does not respond to a connection attempt; future attempts to transmit the prepared content to the mobile device are prohibited.

### BACKGROUND

This disclosure relates, in general, to mobile communication networks and, more specifically, to mobile location based advertising.

Targeting content and, particularly, advertising content, to the people who would be most interested in such content is a prime goal of advertising and most recently, digital media advertising. Television and radio advertising is broadcast to the mass market. Although viewing polls can give an estimate of the demographics or persons most likely to watch or listen to a specific program, such as the news, business reports, sports, etc., mass broadcast advertising is necessary since it is impossible to identify exactly who is within the viewing range of a particular television set or the listening range of a particular radio.

The identification of users of network connected devices, such as computers, mobile devices including cellular telephones, PDA's, etc., is easier since the network contains an identification of a particular computer or mobile device user when the network is set up or activated by the user. However, the identity of a specific user of a computer or mobile device at any one instant is assumed to be the registered owner of the computer or the mobile device and not someone who merely has access to the computer or who was loaned the mobile device for temporary use.

Short range radio communication technology, such as the commercially available Bluetooth technology, is used to provide short range, close proximity wireless communication between network compatible devices such as a computer coupled to a network and a mobile device, such a cellular telephone, PDA, etc. Proximity marketing appliances have been devised which utilize such short range wireless communication technology to broadcast advertising content to mobile devices as such mobile devices come within range of the proximity marketing broadcasting appliance. Such proximity marketing appliances have been used in retail establishments, such as restaurants, to broadcast advertising content to users of mobile devices as the users enter the restaurant.

Extensive efforts have been made to customize such short range advertising content to each particular user based on user profiles generated by prior visits of each user to a particular restaurant or retail store. In this manner, advertising content specific to a particular time of day, such as breakfast, lunch or dinner, or advertising based on prior purchases by the mobile device user in the restaurant, can be broadcast at a corresponding particular time of day when the user of a mobile device comes within range of a proximity marketing appliance in a restaurant or retail store. Such advertising content can also be selected and broadcast to each user based on gender, age and other demographic characteristics of the mobile device users.

Advertising campaigns typically run for a brief period of time, such as one day, one week, one month, etc., to keep current with changing offerings at the retail or restaurant, as well as to promote new products or the existing products in a new manner more likely to attract customers. Thus, advertising campaigns frequently undergo revision or are replaced with completely new advertising campaigns containing new content.

The desire to target advertising to a particular user based on a user profile as well as the need to frequently revise the content of such advertising results in complexity in creating and distributing advertising content on a continuing basis. Currently, the computer or entity which controls the distribution of a particular piece of advertising content or an entire advertising campaign to a particular proximity marketing appliance in a restaurant or retail store is controlled by a computer network service company. Such companies interact with the merchant or the advertising company associated with the merchant who creates the new advertising content. Such new advertising content is delivered to the network service company who then controls its distribution to each proximity marketing appliance. This results in delays in implementing and distributing new advertising content to merchants as well as receiving acceptance or denial feedback from the mobile devices of customers in response to such targeted advertising.

It will be desirable to provide a proximity marketing apparatus which simplifies the distribution of advertising content.

### SUMMARY

A method for delivering content to at least one mobile device is disclosed which includes the steps of accessing discrete prepared content; transmitting the prepared content to a proximity broadcast node; storing the prepared content in the proximity broadcast node; detaching by the proximity broadcast node if a mobile communication device with wireless communication capability is within a data communication range of the proximity broadcast node, attempting to establish a peer-to-peer connection with the detected mobile communication device within the data communication range; and when a peer-to-peer connection is established, delivering by the proximity broadcast node the prepared content to the mobile communication device.

The attempt to establish a connection further comprises the steps of: retrying the attempt if a prior attempt is ignored by the user of the mobile communication device, and discontinuing the attempt to establish a connection when the user of a mobile communication device declines a connection attempt prohibiting future attempts to establish a connection with the user of the mobile communication device.

The prohibitions are checked before an attempt to establish a connection with a mobile communication device

When an attempt to establish communication as accepted by the user of a mobile communication device; identifying the identification of one of the users of the mobile communication device and the mobile communication device as preferred mobile communication device identification for future communication attempts.

An application is coupled to the node configured for detecting if a mobile communication device with wireless communication capability is within a data communication range of the proximity broadcast node attempting to establish a peer-to-peer connection with the mobile communication device within the data communication range; and when a peer-to-peer connection is established, delivering the prepared content to the mobile communication device by the proximity broadcast node.

### BRIEF DESCRIPTION OF THE DRAWING

The various features, advantages and other uses of the present invention will become more apparent when referring the following detailed description and drawing in which:

FIG. 1 is a block diagram of a proximity marketing server apparatus;

FIGS. 2A and 2B are process flow diagrams of the server portion of the proximity marketing apparatus shown in FIG. 1;

FIGS. 3A and 3B are process flow diagrams of a wireless communication transmission apparatus usable as Device 2 in FIG. 1; and

FIGS. 4-12B are screen displays of various features of the apparatus.

### DETAILED DESCRIPTION

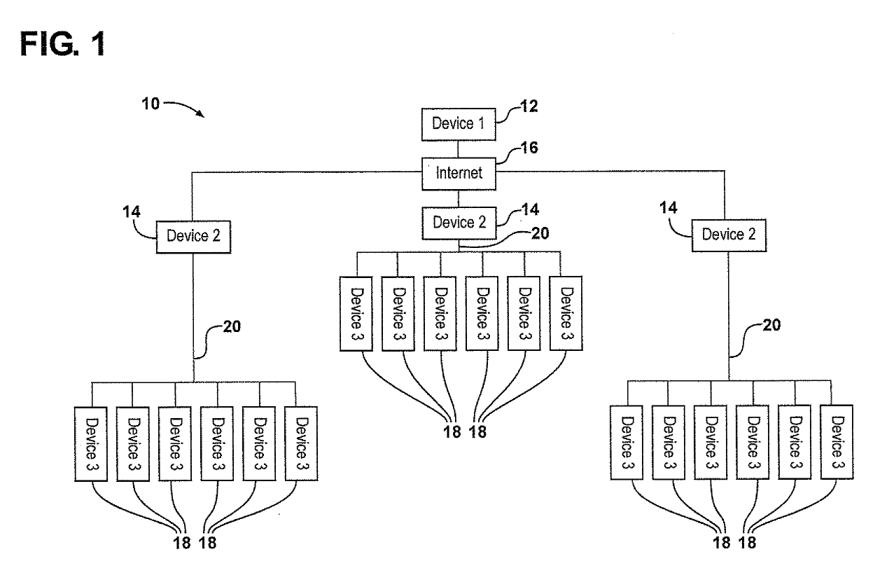

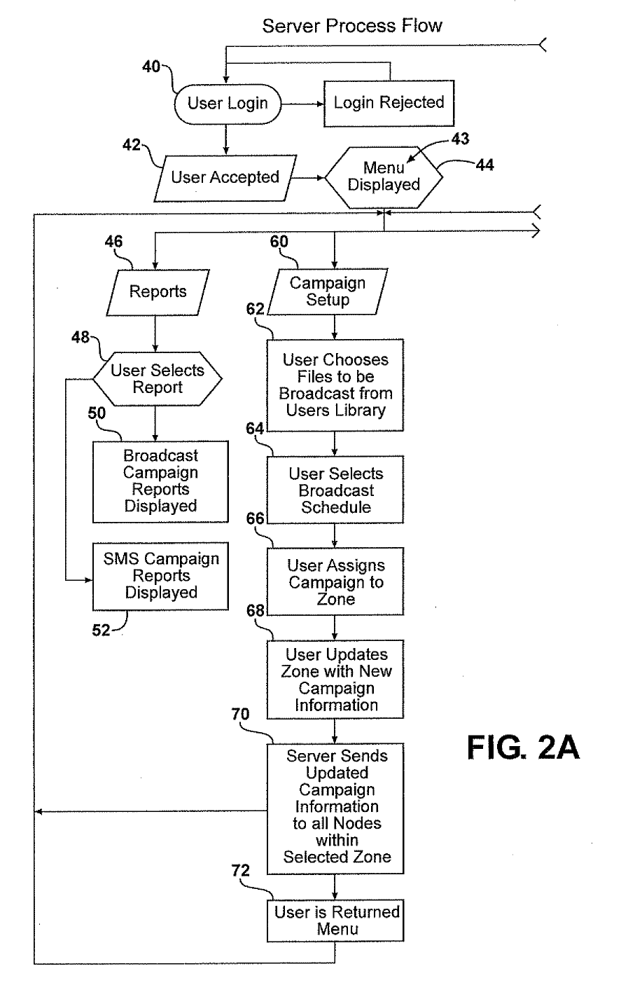

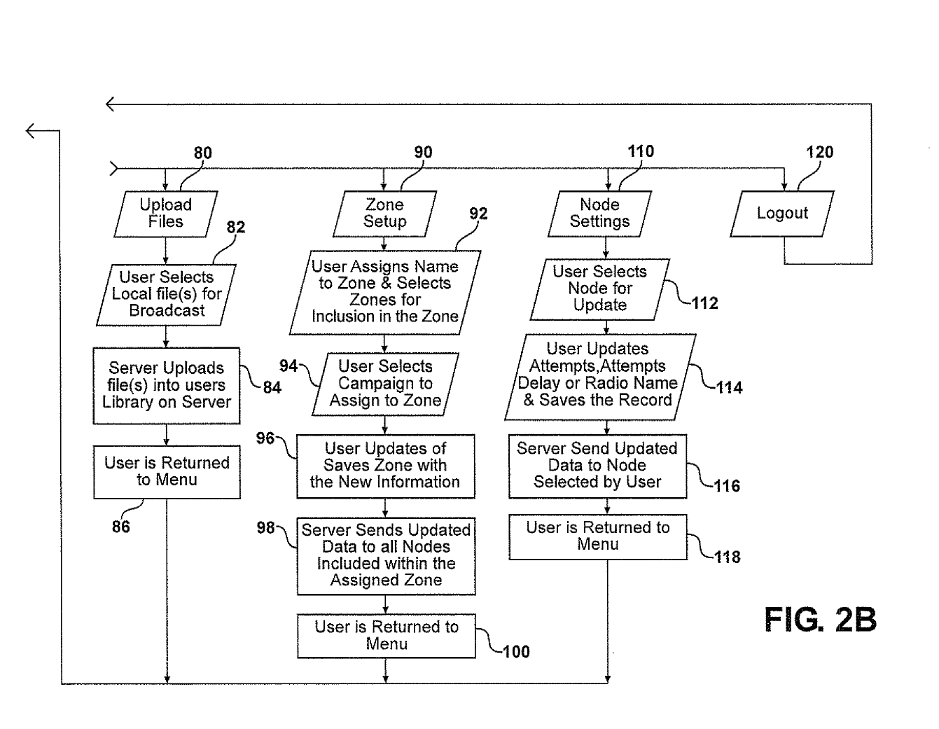

Referring now to FIG. 1, there is depicted a general block diagram of a proximity marketing apparatus denoted generally by reference number 10. The apparatus 10 includes a Device 1 denoted by reference number 12 which is a computer based server operating a proximity advertising a software program shown in FIGS. 2A and 2B. The server 12 is an Internet connected server which hosts control panel software used to send files or data to and receive files or data from one or more devices 2, also referred to by reference number 14, through the Internet 16 either continuously or intermittently.

The device 1 can be any Internet enabled device, such as a laptop computer, a PC, a PDA, etc., configured for wireless communication. The device 1 can be hard wired connected and/or wirelessly connected to the Internet 16.

Each device 2 includes a wireless transmitter which wirelessly transmits data to or receives data from one or more wireless broadcast enabled mobile devices 18. Seven mobile devices 18, each labeled device 3 in FIG. 1, are shown by way of example only, as wirelessly linked to one device 2.

The mobile devices 18 may be cellular telephones, PDA's, etc., for example only. The following description makes use of Bluetooth wireless enabled communication links 20 between each node 14 and the plurality of devices 18 linked to a particular node 14. This is, by way of example only, as any wireless communication protocol may be employed for the wireless communication link denoted by reference number 20. The wireless communication link 20 may have a preset or effective range, such as 100 meters by example only.

When activated, as described hereinafter, the node 14 will attempt to connect with at least one or up to a plurality of mobile devices 18, such as seven mobile devices 18 as shown by example in FIG. 1, simultaneously to send or receive files and/or data on a peer to peer permission basis.

The node 14 may be a stand alone ITX style computer or a desktop laptop computer or PDA with USB connections and using a custom embedded Microsoft based operating system designed to run the software program described hereafter. The processor in the node 14 may be in a stand alone housing located at an end user location, such as a restaurant, or the software may be embedded in a USB dongle which is connectible to any computer, such as a laptop, desktop, PDA, etc., at the end user location.

Key information on each node 14 is input to the control panel in the server 12 to identify each node 14 and the owner of the node 14 on the server 12 network.

The control panel process flow accessible through the server 12 is shown in FIGS. 2A and 2B.

The user first logs in step 40. After successfully completing a login accepted procedure in step 42, the main menu 43 of the control panel is displayed in step 44. The main menu 43 allows the user, such as the advertising agency or the company who wishes to present an advertising campaign to one of the mobile devices 18, to choose between a plurality of actions, including reports, campaigns, set up, upload files, zone set up, node settings and, finally, logout.

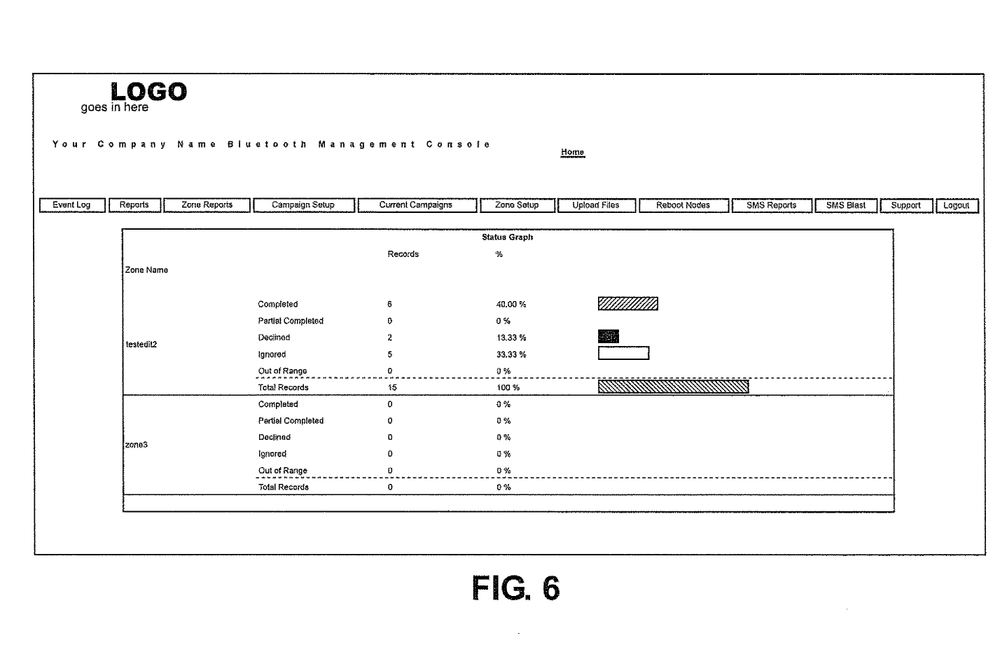

When the user selects reports in step 46, a menu of the various reports is presented on the control panel allowing user selection in step 48. The user can select between a broadcast report display in step 50 and SMS campaign report in step 52. Samples of such reports are shown in FIGS. 6,8,10 and 11.

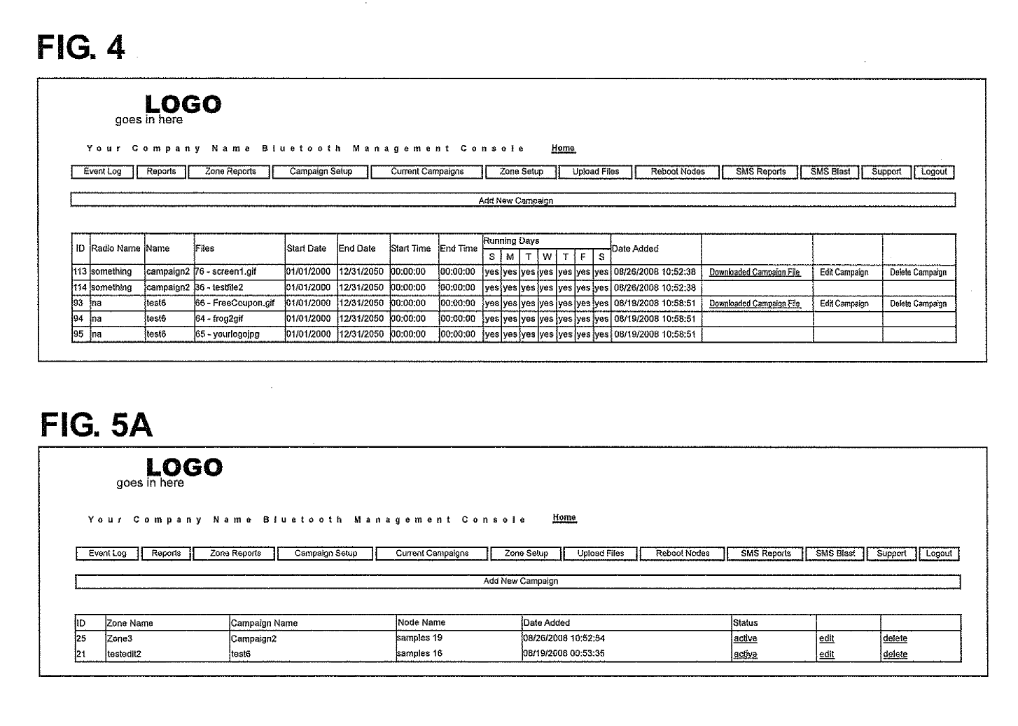

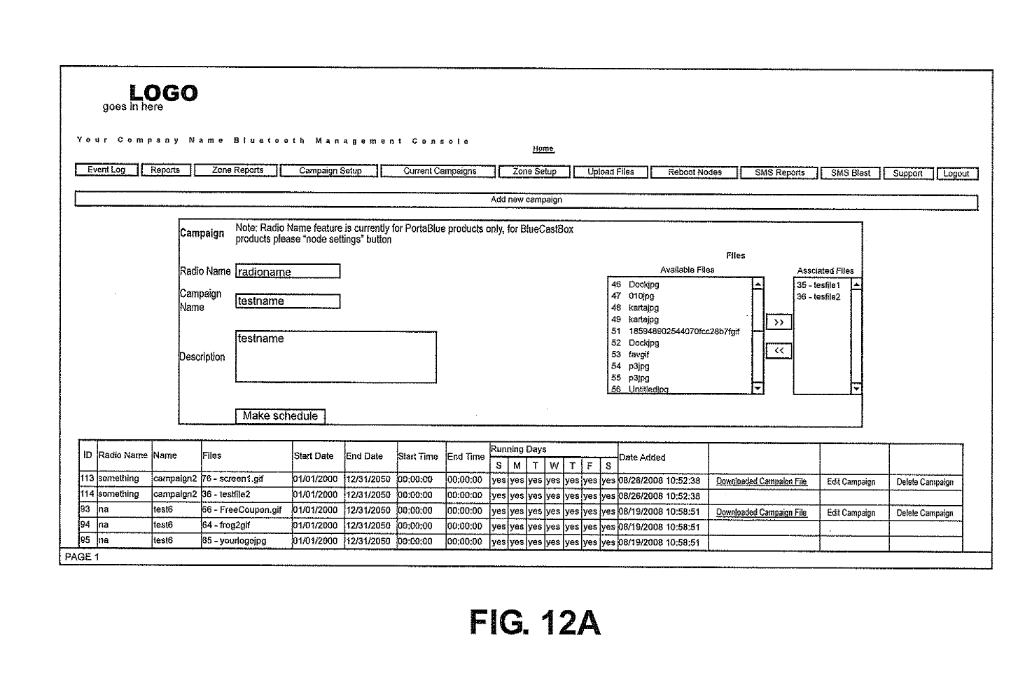

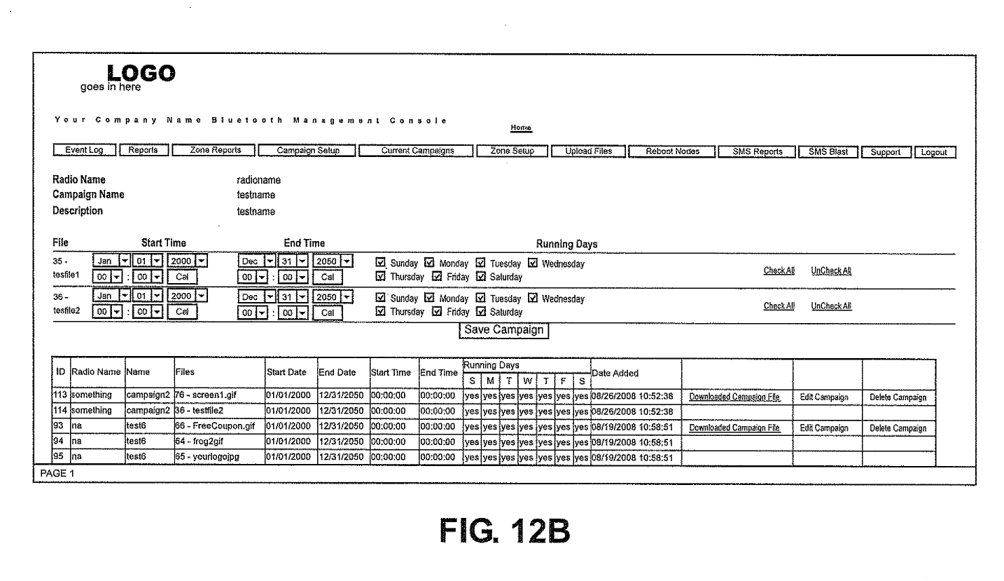

When the user selects campaign set up in step 60 from the main menu 43, the user can input the files to be broadcast from the user's library, see FIGS. 4, 12A and 12B, which may be stored in a computer, animated GIF, an MP3 Player, etc., in step 62, to the server 12. The files contain digital content such as text, sound, video or any combination thereof.

The user is then presented in step 66 with a menu allowing the user to select a broadcast schedule for the selected advertising campaign. The schedule may consist of one or more files containing discrete advertising which can be set by the user to broadcast only on certain days, certain times of days to certain groups of customers, etc.

The user next assigns the selected advertising campaign to a zone in step 66 and then, in step 68, updates the zone with the new advertising campaign information.

The user can then elect to select in step 70 to send the updated campaign information to all of the nodes 14 within the selected zone. The user is then returned in step 72 to the main menu 43.

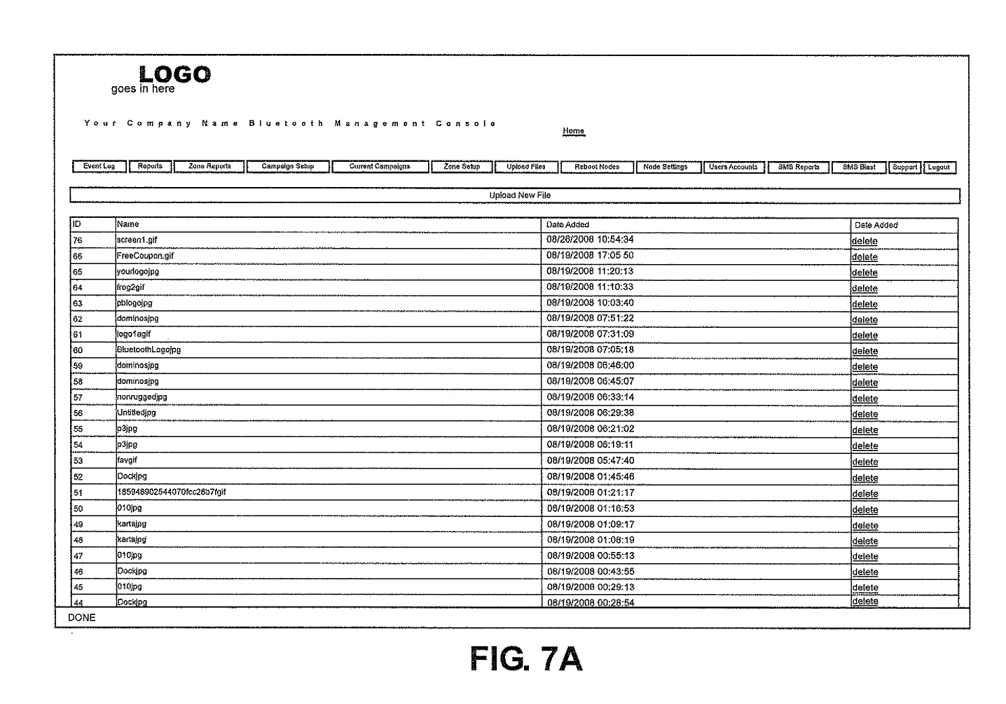

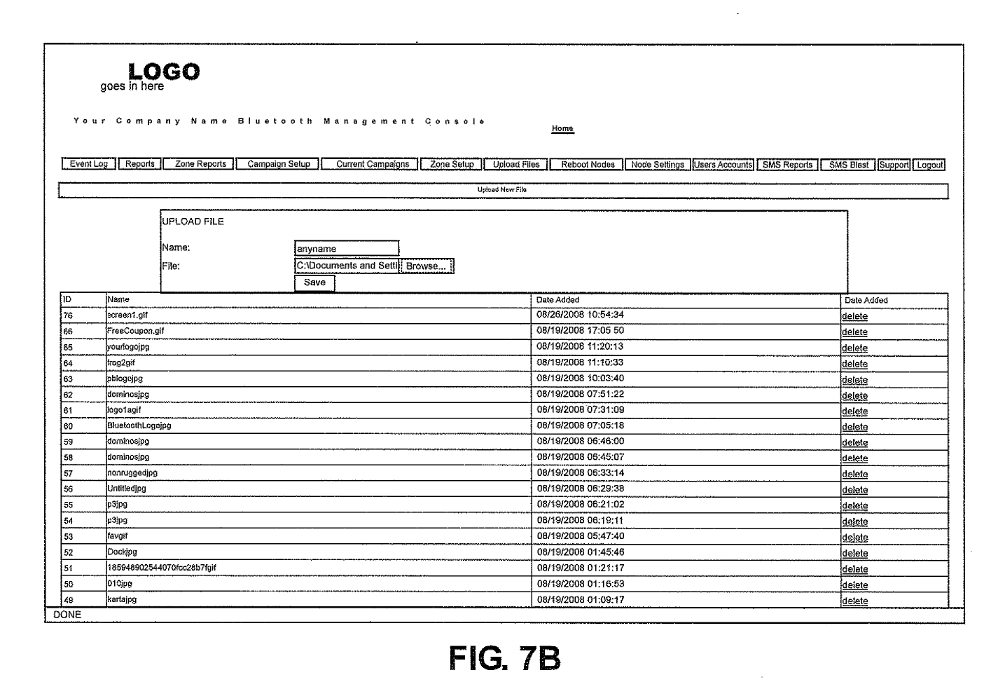

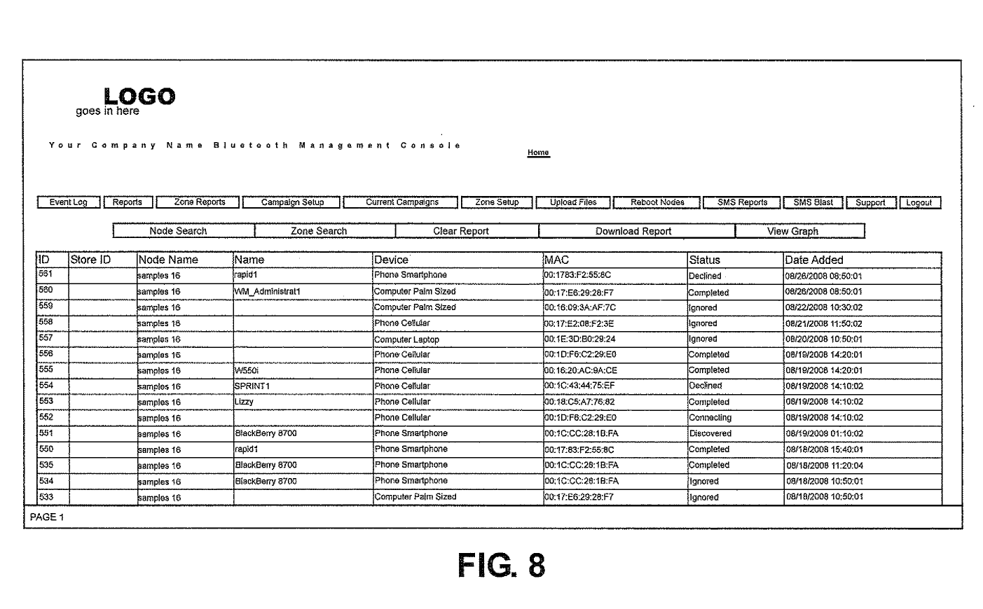

From main menu 43, the user can also elect in step 80 to upload files for broadcast. The user can then select in step 82, the local file or files for broadcast, see FIGS. 7A and 7B. The user then uploads the files into the user's library on the server 12 in step 84 before being returned to the main menu 43 in step 86.

From the main menu 43, the user can also set up a zone in step 90. By way of example, a zone is a group of nodes 14. This group of nodes 14 can be a single node 14 or a plurality of nodes such as up to 5,120 nodes 14, for example.

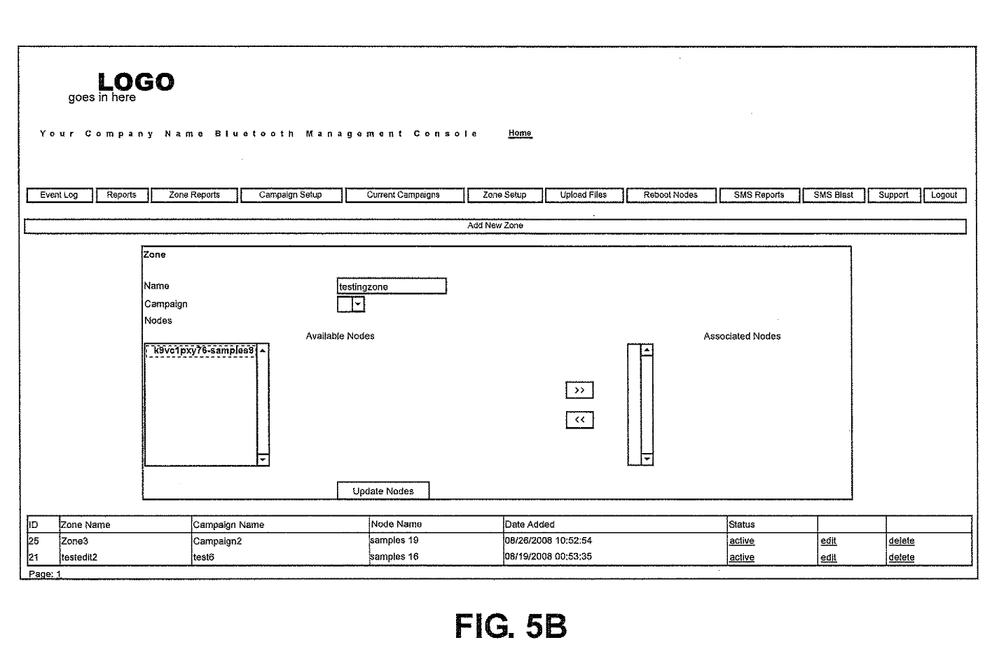

When the zone setup window is selected in step 90, the user assigns an identifier or name to each zone see FIGS. 5A and 5B and then selects zones for inclusion in the zone in step 92. The user then assigns an advertising campaign to the selected zone in step 94. The user then updates or saves the new information in the assigned zone in step 96. Finally, the user sends the updated data to all nodes 14 included within the assigned zone in step 96 before returning the main menu 43 in step 100.

A node 14 can be assigned to only one zone, for example. However, advertising campaigns can be assigned to many separate zones.

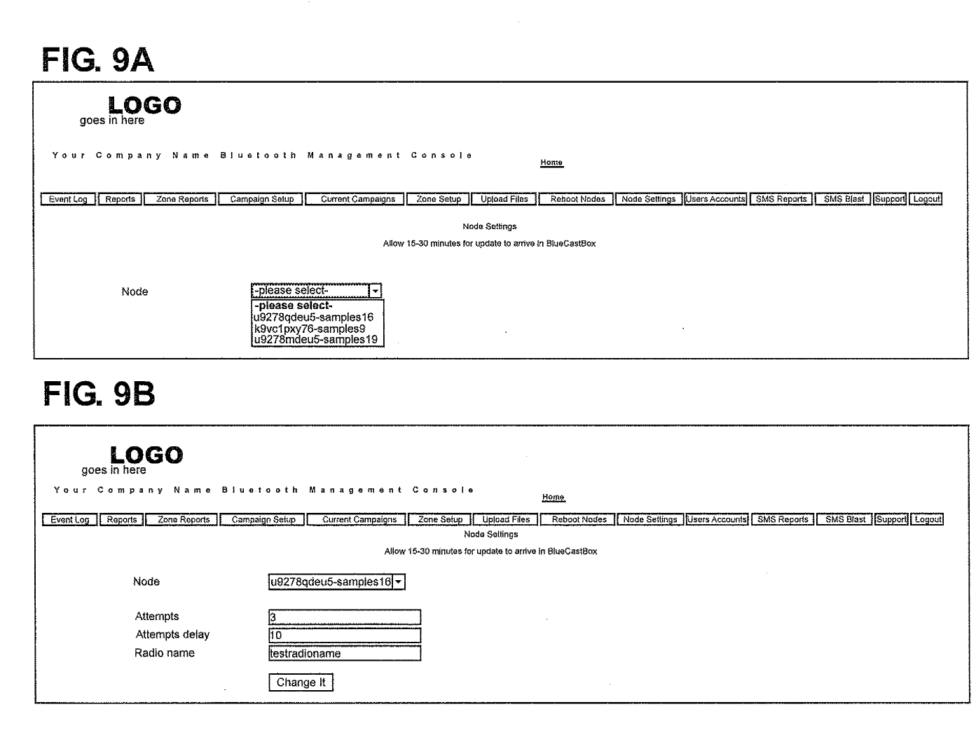

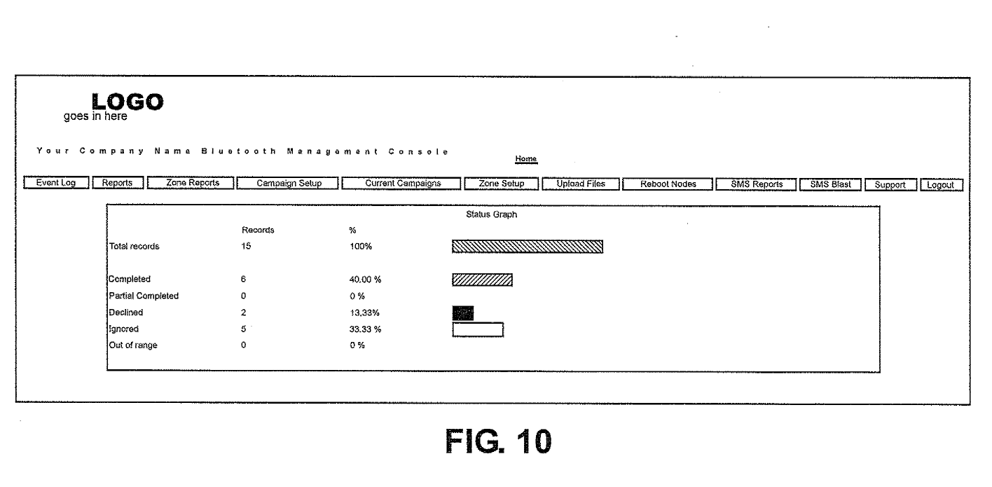

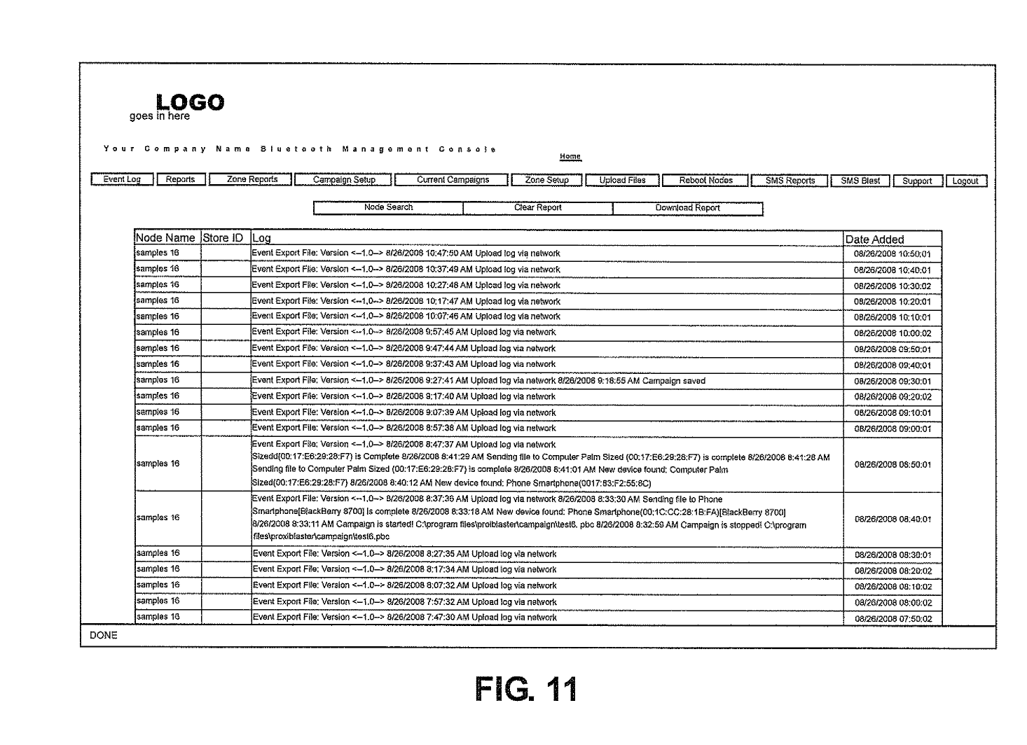

If the user selects node settings from the main menu 43 in step 110, a node setting window, see FIG. 9A or 9B is opened in the control panel. From the node settings windows in step 110, the user can select a particular node for settings update in step 112. The user can then update the attempts, delay or radio name for the selected node 14 and then save the settings in step 114. The user can then send the updated node setting data to the selected node in step 116 before being returned to the main menu 43 in step 118.

Finally, the user may select to logout in step 120 from the main menu 43.

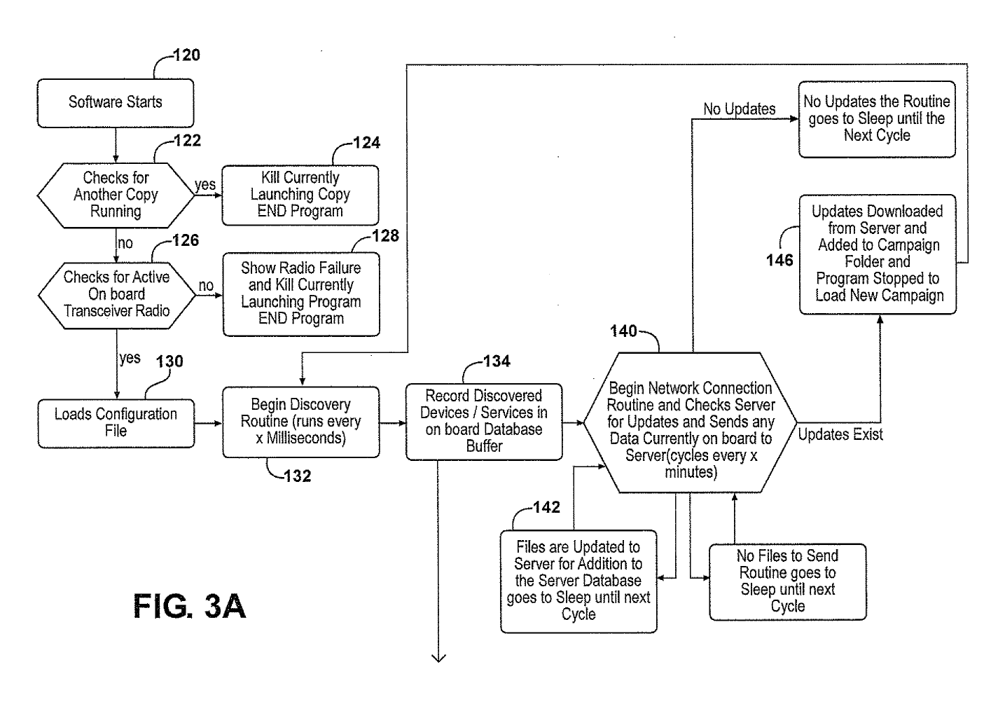

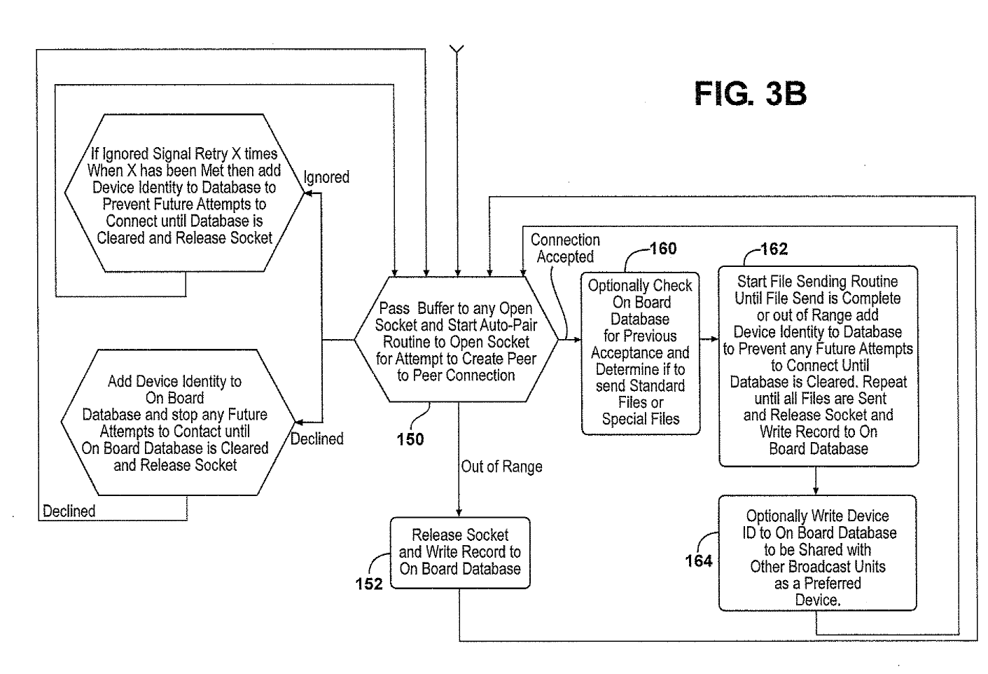

Each node 14 includes control software shown in FIGS. 3A and 3B. Once one of the nodes software is activated in step 120, the control software checks whether another copy of the control is running in step 122. If another copy is running, the software stops the currently launched copy and ends the program in step 124. If another copy of the control program is not running, the control program checks for an active on board transceiver radio in step 126. If there is a radio failure, the software stops the currently launched program and ends the program in step 128.

If the onboard transceiver radio is active, the software loads the configuration file for the node 14 in step 130 and then begins a discovery routine which runs every predetermined time period, such as every X milliseconds in step 132. The discovery routine in step 132 uses the Bluetooth enabled wireless connection to determine if a Bluetooth enabled mobile device 3 is turned on and within range of the node 14. If the device 3 is detected, data about the discovered device 3 is recorded in the onboard data base buffer of the node 14.

The node 14 controls and initiates step 140 which begins a network connection routine and checks the server 12 for updates and sends any data currently in the onboard database buffer to the server 12. This connection routine may be cyclical in nature and recycle every X time period, such X minutes. If the onboard database buffer has files, the files are uploaded in step 142 to the server 12 for addition to the server 12 database.

If updates are available from the server 12, the node 14 software downloads the updates from the server 12 in step 146 and adds the updates to the selected campaign folder. The node 14 control then stops the control program to load the new campaign information and then returns to begin the discovery routine step 132.

After all files have been uploaded to the server 12 and all updates downloaded from the server 12, if the node 14 detects an active mobile device 3 within range which is Bluetooth or otherwise wireless enabled, the node 14 passes the discovered device data in the onboard database buffer to one of the open sockets of the node 14. As described above, the node 14 may have one or more sockets for connecting to one or more mobile devices 3. Seven sockets for connection to seven mobile devices 3 each on a peer to peer permission basis are provided for each node 14 by way of example only. The node control then starts an auto-pair routine to open the socket for an attempt to create a peer to peer connection in step 150. If the detected mobile device 18 moves out of wireless connection range, the node 14 releases the socket and writes a record to the onboard database in step 152.

If the signal from the auto-pair routine is ignored by the mobile device 3, the node 14 initiates one or more retries to establish a peer to peer connection with a specific mobile device 3 detected within the range of the node 14. After X unsuccessful retries, the node 14 then adds the identity of the detected mobile device 3 to the database on a list, hereinafter referred to by example as a prohibited list or “blacklist”, to prevent future attempts to connect to that mobile device 3 after the database is cleared to the node 14 releases the socket.

Alternately, the user of a mobile detected device 3, after receiving notice of an attempted peer to peer connection from the node 14, may decline to receive the campaign or advertising data. The node 14, upon receiving a decline message from the user of the mobile detected device 3, adds the mobile device identity to the onboard database in the “blacklist” and stops any further attempts to contact the user of the mobile detected device 3 until the onboard database is clear. The node 14 then releases the node socket.

It should be noted that the “blacklist” can be universal for a particular customer in that the device identities added to the “blacklist” may remain in the “blacklist” associated with one specific zone or one specific node 14 or all of the zones and nodes associated with a particular customer. Alternately, the “blacklist” may remain intact to prevent future attempts to contact the user of a specific mobile device 3 only until the node 14 database is cleared of campaign data, such as at the end of a specific advertising campaign. Once the buffer is cleared, the user identity of a previously detected mobile device 3 which ignored a signal from the node 14 or declined to receive further data from the node 14 can be removed from the “blacklist” for example, so as to enable future attempts to connect.

Universal, means for example, if a mobile device user specifically declines to receive advertising, the device mobile ID may remain in the onboard database file and stored in the server 12 permanently thereby prohibiting any future attempts to contact the specific mobile device 3 during an ongoing advertising campaign or in any subsequent campaigns. This prohibition on future attempts may also apply to the all of the nodes 14 within a zone or all of the nodes or zones associated with a particular customer, such as a restaurant chain etc.

Alternately, the identity of a specific mobile device in the blacklist may be maintained only for the duration of a particular advertising campaign. Once the advertising campaign is over, the user of that mobile device 18 may be subject to future connection attempts for advertising campaigns when the specific mobile device 3 is detected within range of node 14.

If a connection is accepted by detected mobile device 3 from step 150, the node 14 control program checks the onboard database buffer for an indication of previous acceptances by the user of the detected mobile device 3 which has accepted connection. Depending on configuration of the files, the node 14 may then send standard campaign files or special files to the detected mobile device 3 in step 160. If a user of a mobile Device 18 accepts a connection from the node 14, the onboard database creates a so called “Whitelist” which contains the mobile device ID's of all users who have previously accepted a connection request from the node 14. It should be noted that the previous connection acceptances may apply to all nodes 14 within a particular zones as well as to all of the zones associated with the particular advertising campaign owner.

The node 14 in step 162 then starts the file sending routine until the file send is complete or the mobile device 3 is out of range. The node 14 then adds the detected mobile device 18 identity to the onboard database buffer to prevent any future attempts to connect to the specific mobile device 18 with the same advertising campaign until the database is cleared. This prevents the same advertising campaign from being resent to the same mobile device user while the same advertising campaign is active.

The file sending routine is continued until the entire file or files are sent. The node 14 then releases the socket and writes a record to onboard database of the mobile device ID, campaign ID, etc.

Optionally, in step 164, the node 14 can write the detected mobile device 3 ID to the onboard database to be uploaded to the server 12 as described above, for sharing with other broadcast units or nodes 14 as a preferred mobile device 18.

What is claimed is:

1. A method for delivering content to at least one mobile device comprising the steps of:
accessing discrete prepared content;
transmitting the prepared content to a proximity broadcast node;
storing the prepared content in the proximity broadcast node;
detecting the proximity broadcast node if a mobile communication device with wireless communication capability is within a data communication range of the proximity broadcast node:
attempting to establish a peer-to-peer connection with the detected mobile communication device within the data communication range; and
when a peer-to-peer connection is established, delivering by the proximity broadcast node the prepared content to the mobile communication device.

2. The method of claim 1 wherein the step of attempting to establish a connection comprises the steps of:
retrying the attempt if a prior attempt is ignored by the user of the mobile communication device; and
discontinuing the attempt to establish a connection.

3. The method of claim 2 further comprising the step of:
when the user of a mobile communication device declines a connection attempt prohibiting future attempts to establish a connection with the user of the mobile communication device.

4. The method of claim 3 wherein the prohibiting step further comprises the step of:
storing an identification of the mobile communication device on a future attempt prohibition list.

5. The method of claim 3 further comprising the step of:
removing the prohibition when the prepared content is or replaced by new content.

6. The method of claim 3 further comprising the step of:
checking for prohibitions before the step of attempting to establish a connection with a mobile communication device.

7. The method of claim 1 further comprising the step of:
when an attempt to establish communication is accepted by the user of mobile communication devices; identifying the mobile communication device as a preferred mobile communication device for future communication attempts.

8. The method of claim 1 further comprising the step of:
using a server for accessing the prepared content and for transmitting the prepared content to a proximity broadcast node; and
storing by the server a list of mobile communication devices with which attempts to establish a connection are either prohibited or allowed.

9. The method of claim 8 further comprising the step of:
uploading an identification associated with a detected mobile communication device to the server.

10. The method of claim 8 further comprising the step of:
connecting the server and the node by a communication network.

11. The method of claim 10 further comprising the step of:
using the Internet as the communication network.

12. The method of claim 1 wherein the step of detecting if a mobile communication device is within the data communication range of the node further comprises the step of using a short range communication protocol for detecting.

13. The method of claim 1 wherein the detecting and attempting steps further comprise the step of:
determining if a plurality of mobile communication devices are within the data communication range of the node; and
attempting to establish a peer-to-peer connection with each of the mobile communication devices detected within the data communication range.

14. The method of claim 8 further comprising:
assigning the node to a zone.

15. The method of claim 8 further comprising the steps of:
establishing a zone by the server; and
assigning at lease one node to the zone by the server.

16. The method of claim 8 further comprising the steps of:
selecting the prepared content by the server;
selecting a broadcast schedule for the node by the server;
updating the zone with new prepared content; and
transmitting the new prepared content to each zone.

17. The method of claim 8 further comprising the step of:
updating the number of node attempts to establish communication with any mobile communication devices to the server.

18. A method for delivering content to at least one mobile device comprising the steps of:
means for accessing discrete prepared content;
means for transmitting the prepared content to a proximity broadcast node;
means for storing the prepared content in the proximity broadcast node;
means for detecting the proximity broadcast node if a mobile communication device with wireless communication capability is within a data communication range of the proximity broadcast node:
means for attempting to establish a peer-to-peer connection with the detected mobile communication device within the data communication range when a peer-to-peer connection is established;
means for delivering by the proximity broadcast node the prepared content to the mobile communication device.

19. An apparatus for delivering content to at least one mobile communication device comprising:
a server;
a proximity broadcast node;
the server and the node connected in data communication by a network;
an application coupled to the node, the application configured for:
detecting if a mobile communication device with wireless communication capability is within a data communication range of the proximity broadcast node:
attempting to establish a peer-to-peer connection with the detected mobile communication device within the data communication range; and
when a peer-to-peer connection is established, delivering the prepared content to the mobile communication device by the proximity broadcast node.

20. The apparatus of claim 19 wherein the application:
retries the attempt if a prior attempt is ignored by the user of the mobile communication device; and
discontinues the attempt to establish a connection.

21. The apparatus of claim 20 wherein the application further comprises:
when the user of a mobile communication device ignores a connection attempt by the proximity broadcast node, the application prohibiting future attempts to establish a connection with the user of the mobile communication device.

22. The apparatus of claim 21 wherein the application:
stores an identification of the mobile communication device on a future attempt prohibition list.

23. The apparatus of claim 22 wherein the application further comprises:
removing the prohibition when the prepared content is replaced by new content.

24. The apparatus of claim 22 wherein:
the application checks for prohibition before the step of attempting to establish a connection with a mobile communication device.

25. The apparatus of claim 19 wherein the application further comprises:
an attempt to establish communication as accepted by the user of a mobile communication device;
identifying the mobile communication device as a preferred mobile communication device for future communication attempts.

26. The apparatus of claim 19 further comprising:
a server accessing the prepared content and transmitting the prepared content to a proximity broadcast node; and
the server storing a list of mobile communication devices with which attempts to establish a connection are either prohibited or allowed.

27. The apparatus of claim 26 further comprising:
the application uploading an identification associated with a mobile communication device to the server.

28. The apparatus of claim 26 further comprising:
the server and the node coupled by a communication network.

29. The apparatus of claim 28 wherein:
the communication network is the Internet.

30. The apparatus of claim 19 wherein application detects a mobile communication device within the data communication range of the node further by using a short range communication protocol.

31. The apparatus of claim 19 wherein the application:
detects if a plurality of mobile communication devices are within the data communication range of the node; and
attempts to establish a peer-to-peer connection with each of the mobile communication devices detected within the data communication range.

32. The apparatus of claim 19 further comprising:
the server assigning the node to a zone.

33. The apparatus of claim 32 further comprising of:
the server establishing a zone; and
the server assigning at least one node to the zone.

34. The apparatus of claim 32 further comprising the server:
selecting prepared content filed;
selecting a broadcast schedule for the node;
updating the zone with new content; and
transmitting the new content to each zone.

35. The apparatus of claim 32 further comprising:
the node updating to the server the number of node attempts to establish communication with any mobile communication devices.
